(19) United States
(12) Patent Application Publication
(10) Pub. No.: US 2007/0198873 A1
(43) Pub. Date: Aug. 23, 2007

(54) Method of Operation of a Microprocessor

(75) Inventors: David Dewick Ward, Swadlincote, Derbyshire (GB); James Alan Flint, Loughborough, Leicestershire (GB); Vassilios Apostolos Chouliaras, Loughborough, Leicestershire (GB); Emmanuel Touloupis, Anavyssos (GR)

Correspondence Address: GREENLEE WINNER AND SULLIVAN P C, 4875 PEARL EAST CIRCLE, SUITE 200, BOULDER, CO, 80301, US

(73) Assignees: MIRA LIMITED, Nuneaton (GB); LOUGHBOROUGH UNIVERSITY, Loughborough (GB)

(21) Appl. No.: 11/565,874

(22) Filed: Dec. 1, 2006

(30) Foreign Application Priority Data
Dec. 3, 2005 (GB) 0524765.5

(51) Int. Cl. G06F 11/00

(52) U.S. Cl. 714/49

(57) ABSTRACT

The invention relates to a microprocessor and a method of operation thereof. More particularly this invention relates to a microprocessor, having at least three pipeline execution units which operate in lockstep. In an embodiment, the method of operation of a microprocessor accounts for the occurrence of transient faults or Single Event Upsets in one of its pipeline execution units such that their occurrence is unlikely to result in failure of the microprocessor as a whole.

### CROSS-REFERENCE TO RELATED APPLICATION

This application claims priority under 35 U.S.C. §119 to Application No. GB0524765.5 filed Dec. 3, 2005, which is hereby incorporated by reference in its entirety to the extent there is no inconsistency with the present disclosure.

### BACKGROUND OF THE INVENTION

This invention relates to a microprocessor and a method of operation thereof. More particularly this invention relates to a microprocessor, having at least three pipeline execution units which operate in lockstep.

### DESCRIPTION OF THE PRIOR ART

The successful use of fly-by-wire systems in aviation along with the positive experience of drive-by-wire systems with a mechanical back-up for braking and power steering of motor vehicles have led to increased interest in the developments of full authority drive-by-wire systems, particularly for motor vehicles. Such full authority drive-by-wire systems would reduce the overall cost of the vehicle, are lighter when compared to mechanical systems, and are able to provide enhanced safety for the driver and passengers of the motor vehicle.

However, it is clear that the fault modes of such a drive-by-wire system are different from an equivalent mechanical system. Furthermore the behaviour, including the manifested hazards, of such a system in the presence of one or more unprotected faults may vary considerably from the behaviour anticipated by users accustomed to mechanical systems. For this reason, there are some acceptability issues from both customers and legislative bodies.

Drive-by-wire systems can be defined as electronic or electrical systems or sub-systems which have direct control of the vehicle and can be implemented to control a particular function of the vehicle, e.g. braking or steering. The three basic by-wire systems envisaged for the automotive industry are throttle-by-wire, brake-by-wire, and steer-by-wire. Throttle-by-wire systems that are already available in motor vehicles use redundancy for fault-tolerance and have a fail-safe operation. Brake-by-wire systems are also used, which in one example utilise electro-hydraulic control with a limited authority hydraulic backup. Brake-by-wire systems could also utilise full authority electro-hydraulic control and these systems would provide a degree of tolerance to failure by the fact that the braking force can be applied on all four wheels and there is no single point of failure. Steer-by-wire systems are more challenging in that their concept of operation does not offer easy alternative solutions in case of failure. On failure a driver's input to the steering wheel that he/she required a change of direction of the vehicle, could result in the wheels not changing direction, which could result in an accident.

Known drive-by-wire systems have the form of a distributed real-time computer system with several sensor, actuator and control nodes communicating through a duplicated fault-tolerant real time network. The general practice to achieve fault tolerence is to duplicate, triplicate, or even quadruplicate the nodes and/or the processors in the nodes and the cost of packaging constraints in the automotive industry makes this technique impractical. Advances in embedded computer system technology enable the design of system-on-chip solutions that could solve this problem by providing a multi-processor computer system with low unit cost and high integrity.

A problem with such systems is that the semiconductor materials from which they are made are by nature sensitive to radiation exposure. Very high radiation levels can actually damage the structure of the semiconductor material, thus causing a permanent fault (usually referred to as a hard fault). Another cause of a permanent fault is electromigration. Electromigration is the movement of metal ions as a result of the flow of electrical charge through the metal wires of the device. This unwanted ion movement can open up metal voids in some parts of the wires, and can cause build up of metal at other sites of the microprocessor which can lead to open-circuits and short-circuits respectively. Open-circuits and short-circuits initially manifest as intermittent faults. The rate of permanent faults in microprocessors and static and dynamic memory has significantly decreased over recent decades due to improvements in manufacturing techniques. As geometries shrink the wire cross-section decreases, thus increasing the sensitivity to electromigration, although the use of copper interconnects has been used to provide better protection.

As well as intermittent and permanent faults that occur after several months of the microprocessor's operation and can be removed by replacing the faulty part thereof, transient faults also occur. A transient fault appears as a single or multi-bit flip (i.e. a change in the contents of a storage cell) but they can also affect combinational circuits. Transient faults are often referred to as Single Event Upsets (SEUs). Transient faults affect the stored charges that represent data inside the microprocessor and can generate an error in a pipeline execution unit which can possibly lead to a failure of the microprocessor. The main sources of such faults are the following:
1) Electrical noise from external sources;
2) Electromagnetic coupling (crosstalk) between microprocessor interconnects;
3) The decay of radioactive material that exists in small amounts in the semiconductor material and the surrounding package that generates alpha particle emissions; and
4) Neutron particles that originate from extraterrestrial cosmic rays that bombard the Earth's surface.

Some of these problems can be minimised with careful selection of materials followed by decontamination and the use of radiation-hardening technology, but in practice these solutions are expensive for commercial applications.

In order to satisfy the low cost requirements of the automotive industry, and other commercial safety-critical applications, the design of a microprocessor suitable for drive-by-wire systems should focus on deleting or masking, or correcting SEUs, rather than preventing them as the associated costs are too high.

It is therefore an object of this invention to provide a method of operation of a microprocessor which accounts for the occurrence of transient faults or SEUs in one of its pipeline execution units such that their occurrence rarely causes the microprocessor as a whole to fail.

### SUMMARY OF THE INVENTION

Therefore, according to the invention there is provided a method of operation of a microprocessor, the microprocessor having at least three identical pipeline execution units, each pipeline execution unit having at least two operation stages, where an N^{th} operation stage is the final operation stage and the n^{th} operation stage is a first or subsequent operation stage up to and including the N^{th} operation stage; at least one shared resource connected to each of the pipeline execution units, the shared resource configured to provide information to each of the pipeline execution units and/or receive information from at least one of the pipeline execution units; a timing device for effecting operation of the pipeline execution units, such that the n^{th} operation stage of each of the pipeline execution units is executed concurrently to provide an output up to concurrent operation of the N^{th} operation stage of each of the pipeline execution units to provide an output; for at least one of the first to n=(N−1•)^{th} operation stages, a device for comparing the outputs of each of the n^{th} operation stages of the pipeline execution units with each other to determine if the outputs disagree; and a device for comparing the outputs of each of the N^{th} operation stages of the pipeline execution units with each other to determine if the outputs disagree, the method including the steps of:
obtaining for each pipeline execution unit an instruction from a shared resource;
using said instruction as an input to a first operation stage of each pipeline execution unit;
for at least one of the first to n=(N−1)^{th} operation stages comparing corresponding outputs of the n^{th} operation stage of each of the pipeline execution units with each other to determine if the outputs disagree;
and, if the output of the n^{th} operation stage of one of the pipeline execution units disagrees with the corresponding outputs of n^{th} operation stage of the other pipeline execution units, the method includes the steps of:
stalling processing by all of the pipeline execution units;
disconnecting operation of the disagreeing pipeline execution unit;
recommencing processing by all of the remaining pipeline execution units after a predetermined period of time;
reconnecting, after a further predetermined time period, the disconnected pipeline execution unit; and
inputting into all of the operation stages of the disconnected pipeline execution unit, prior to its reconnection, correct inputs obtained from the corresponding operation stages one or more of the other pipeline execution units.

The method of operation may include the step of additionally comparing respective outputs of the N^{th} operation stage of each of the pipeline execution units with each other to determine if the outputs disagree, and, if the output of the N^{th} operation stage of one of the pipeline execution units disagrees with the • corresponding outputs of the N^{th} operation stages of the other pipeline execution units, the method may include the step of disconnecting operation of the disagreeing pipeline execution unit.

In addition, for each of the first to the N^{th} operation stages, the outputs of all of the operation stages of each of the pipeline execution units are compared with each other to determine if any of the outputs of one of the pipeline execution units disagrees with the outputs of the other pipeline execution units, and, if the output of the n^{th} operation stage of one of the pipeline execution units disagrees with the corresponding outputs of n^{th} operation stage of each of the other pipeline execution units, the method may include the step of disconnecting operation of the disagreeing pipeline execution unit.

A second operation stage of each pipeline execution unit may use as its input an output of a first operation stage of that pipeline execution unit, and the N^{th} operation stage of each pipeline execution unit may use as its input an output of the (N−1)^{th} operation stage of that pipeline execution unit. More generally, the n^{th} operation stage of each pipeline execution unit uses as its input an output of an (n−1)^{th} operation stage of that pipeline execution unit. Furthermore, the n^{th} operation stage of each pipeline execution unit may use as its input, in addition to or instead of the above, an output from a shared resource.

The predetermined period of time for which processing by all of the pipeline execution units is stalled may be, for example, one or more clock cycles of the timing device of the microprocessor. The predetermined period of time after which the disconnected pipeline execution unit is reconnected may be two or more clock cycles of the timing device of the microprocessor.

The method may include the step of deciding which of the pipeline execution units is the default pipeline execution unit. If the default pipeline execution unit is to be disconnected, the method may include the step of deciding which of the remaining pipeline execution units is to become the default pipeline execution unit. The default pipeline execution unit only may be used to drive the at least one shared resource of the microprocessor.

If an output of the n^{th} operation stage of at least half by number of the active pipeline execution units disagrees with the corresponding output of the n^{th} operation stage of each of the other active pipeline execution units, the method may include the step of entering a recoverable fault state. A subsequent step of the method may then be taking recovery action(s), e.g. resetting the pipeline execution units.

According to a second aspect of the invention there is provided a computer system, incorporating one or more microprocessors operable in accordance with the method of the first aspect of the invention.

According to a third aspect of the invention there is provided a vehicle including a computer system according to the second aspect of the invention.

The computer system of the second aspect of the invention may be, or may be part of, a drive-by-wire, steer-by-wire or brake-by-wire system of the vehicle.

### BRIEF DESCRIPTION OF THE DRAWINGS

Embodiments of the invention will now be described by way of example only with reference to the accompanying drawings of which;

FIG. 1 is a simplified circuit diagram of a microprocessor for use in the method of the present invention; and

FIG. 2 is a flow diagram of the method of the present invention.

### DESCRIPTION OF THE PREFERRED EMBODIMENTS

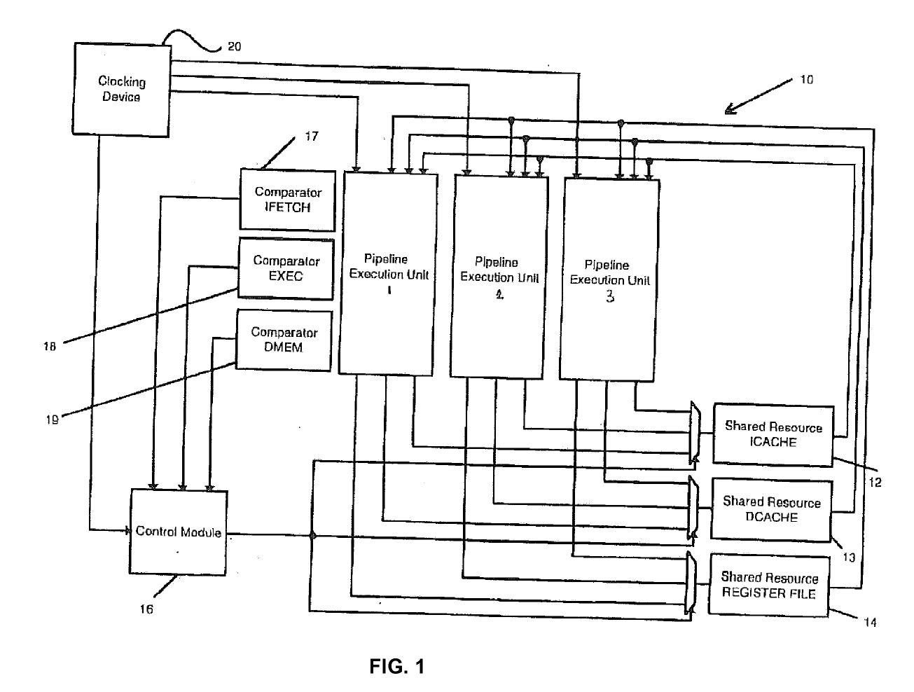

Referring to FIG. 1 there is shown a simplified circuit diagram of a microprocessor 10 in accordance with the present invention. The microprocessor 10 has three electronically identical pipeline execution units 1, 2, 3. By electronically identical it is meant that they are in their operational aspects the same, but that their physical layout could differ. The pipeline execution units 1, 2, 3 in this example are manufactured using a silicon process, but could be, for example, in the form of a bit-stream provided to a field programmable gate array (FPGA) device. Each pipeline execution unit has three (N=3, n=1, 2 or 3) sequential operation stages; an Instruction Fetch (or IFETCH) operation stage, a Decode-Execute (or EXEC) operation stage and a Memory load/store-writeback (or DMEM) operation stage, all of which will be discussed in greater detail later.

It must be appreciated that although the microprocessor 10 has three pipeline execution units, any number of pipeline execution units could be utilised so long as at least three are provided. Furthermore, each pipeline execution unit 1, 2, 3 could have any number of operation stages n so long as there are at least two (i.e. N=2, n=1 or 2).

The pipeline execution units 1, 2, 3 are each connected to three shared resources, indicated at 12, 13 and 14 which are configured to provide instruction to and/or receive instruction from at least one of the pipeline execution units 1, 2, 3. In this example the shared resource 12 is an instruction cache memory (or ICACHE), the shared resource 13 is a Data cache memory (or DCACHE) and the shared resource 14 is a Register file, although other types of shared resources, e.g. further register files, could be utilised. Such shared resources are well known in the art and therefore will not be listed in full here.

The microprocessor 10 also includes a timing device in the form of a clocking device 20. The purpose of the clocking device 20 is to effect operation of the pipeline execution units 1, 2, 3, such that like operation stages of each of the pipeline execution units 1, 2, 3, are executed concurrently. In other words the IFETCH operation stage of each of the pipeline execution units 1, 2, 3 is operated at the same time, followed by concurrent operation of the EXEC operation stages of each of the pipeline execution units 1, 2, 3 and finally concurrent operation of the DMEM operation stages of each of the pipeline execution units 1, 2, 3. It must be appreciated, however, that separate timing device could be provided for each pipeline execution unit 1, 2, 3.

The microprocessor 10 also includes three comparators (or voters), one for each group of like operation stages of the pipeline execution units 1, 2, 3. Thus there is a comparator 17 for the three IFETCH operation stages, a comparator 18 for the three EXEC operation stages and a comparator 19 for the three DMEM operation stages. If the pipeline execution units 1, 2, 3 had more than three operation stages (i.e. N>3) the microprocessor 10 could also be provided with further respective comparators, one for each additional group of like operation stages.

The purpose of each comparator 17, 18, 19 is to compare the three outputs received from the respective n^{th} group of like operation stages of the three pipeline execution units 1, 2, 3 to see if they disagree. The comparators may compare all or part of the outputs received.

The microprocessor 10 also includes a control device in the form of a control module 16, which defines the configuration of the system and receives inputs from each of the comparators 17, 18, 19.

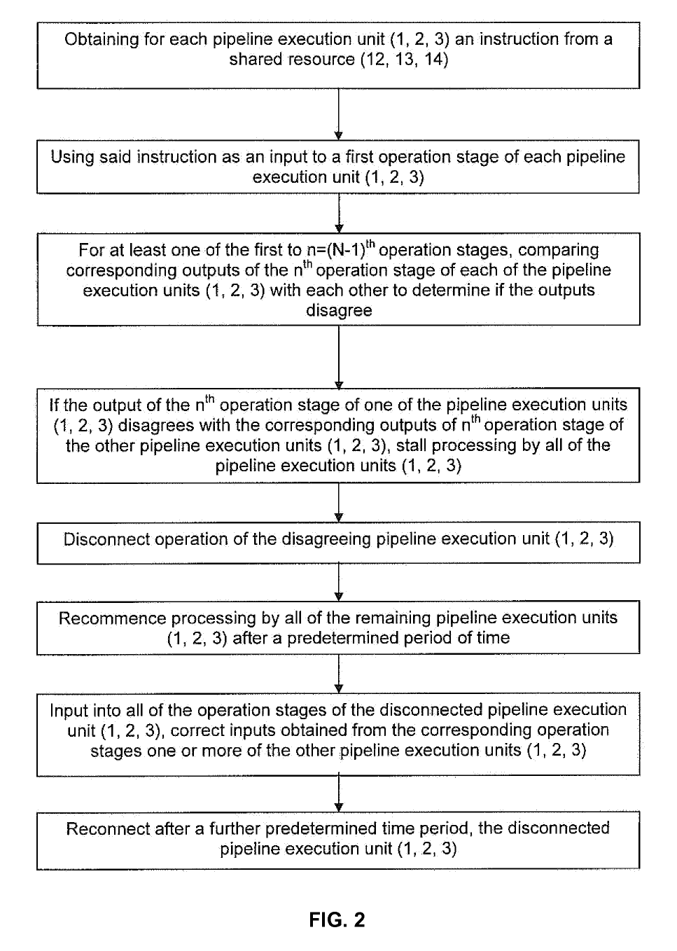

Referring now to the flow diagram of FIG. 2. After a system reset, the state of all three pipeline execution units 1, 2, 3, i.e. the state of each of the n operation stages, is known. From this point on, each operation stage (n) takes as its input the output from the previous operation stage (n−1) together with signals from the shared resources 12, 13, 14. For example, the EXEC operation stage of the pipeline processor 1 takes as its input an output of the IFETCH stage of the pipeline execution unit 1. The pipeline execution units 1, 2, 3 are operated as is well known in the art, i.e. instructions from the ICACHE advance along each pipeline execution unit 1, 2, 3 moving from one operation stage (n) to the next (n+1) every clock cycle of the clocking device 20. The operation of each pipeline execution unit 1, 2, 3 can in general be stalled for a number of clock cycles if that is necessary for correct operation of its instructions.

A function of the control module 16 is to decide which of the three pipeline execution units 1, 2 or 3 is to be the default pipeline execution unit. The default pipeline execution 1, 2 or 3 only is allowed to drive the shared resources 12, 13, 14.

If, for any reason, one of the n^{th} operation stages of one of the pipeline execution units 1, 2, 3 produces a faulty output (e.g. due to a SEU), this will be detected by the control module 16 through the relevant comparator 17, 18 or 19 for that n^{th} group of like operation stages. This is because each comparator 17, 18, 19 uses a majority logic and thus for the microprocessor 10 so long as the outputs of the corresponding n^{th} operation stages of two pipeline execution units agree, the system assumes that the output from the n^{th} operation stage of the remaining pipeline execution unit is incorrect. For a microprocessor having five pipeline execution units, so long as the outputs of the corresponding n^{th} operation stages of at least three of the pipeline execution units agree, the system assumes that the remaining pipeline execution units (two or one) are incorrect. Where there is such a majority, the faulty pipeline execution units(s) output(s) can be “masked”.

As it is within the ambit of this invention to have any number of pipeline execution units so long as there are at least three, there may be rare situations where there is no majority between the outputs of an n^{th} group of like operation stages of the pipeline execution units. This can occur where the microprocessor has an even number of pipeline execution units, e.g. six pipeline execution units, or where the microprocessor has an odd number of pipeline execution units, but one pipeline execution unit has previously been disconnected.

This situation cannot be masked, because the control module 16 has no way of determining which pipeline execution units are correct, and the microprocessor must take recovery actions. In a practical application, for example where the microprocessor was used as part of a drive-by-wire system on a vehicle, if a fault in the microprocessor cannot be masked a signal is sent to trigger an external action. Such an external action may be the operation of a back-up system positioned elsewhere on the vehicle, e.g. a back-up microprocessor 10, to take control of the drive-by-wire system.

A non-majority situation is highly improbable, due to the nature of the mechanism of radiation and EMC induced faults combined with the fact that pipeline execution units are in general very complex and thus they are unlikely to experience common faults concurrently in the different pipeline execution units.

For a situation which can be masked, when the control module 16 determines, via one of the comparators 17, 18 or 19, that an output (or part of an output) from the n^{th} operation stage of one of the pipeline execution units 1 disagrees with the output of the corresponding n^{th} stage of each of the other pipeline execution units 2, 3, the control module 16 stalls the system for one clock cycle of the clocking device 20 and in that clock cycle the control module 16 disconnects the disagreeing pipeline execution unit 1. If the disagreeing execution unit 1 was the default pipeline execution unit chosen by the control module 16 to drive the shared resources 12, 13, 14, the control module 16 chooses one of the other “correct” pipeline execution units 2 or 3 to be the new default pipeline execution unit. It is then this pipeline execution unit 2 or 3 which drives the shared resources 12, 13, 14.

The microprocessor 10 then continues with the remaining pipeline execution units 2, 3, which in this example would result in a “pair” mode situation. Obviously, where there are only two pipeline execution units 2, 3 remaining, any faults would result in the requirement for a system reset or other recovery action as the control module 16 would not know which pipeline execution unit 2 or 3 was correct.

After a predetermined number of clock cycles of the clocking device 20, the control module 16 re-loads into each of the operation stages of the faulty pipeline execution unit 1 correct inputs from the now-default pipeline execution unit 2 or 3. The disconnected pipeline execution unit 1 is then reconnected to the system such that all of the pipeline execution units 1, 2, 3 again run concurrently. If, for example, more than one faulty pipeline execution unit was disconnected they are reconnected concurrently.

Once the faulty pipeline execution unit 1 has been reconnected, the microprocessor 10 operates as it did before the faulty output was detected. If another faulty output is detected from one of the operation stages of one or more of the pipeline execution units 1, 2, 3, the above method of disconnection and reconnection of the faulty pipeline execution unit is repeated.

In the above description the term “output” means the complete output or a part of an output of one of the operation stages of one or more of the pipeline execution units. In other words, where outputs of the pipeline execution units are compared with each other, the comparison may be between the complete outputs or part of the outputs of the operation stages of the pipeline execution units.

Although the microprocessor described above has been discussed with reference to its use in vehicles, the microprocessor in accordance with the present method has many uses outside of vehicles.

One of ordinary skill in the art will appreciate that materials and methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

We claim:

1. A method of operation of a microprocessor, the microprocessor having at least three identical pipeline execution units, each pipeline execution unit having at least two operation stages, where an N^{th} operation stage is the final operation stage and the n^{th} operation stage is a first or subsequent operation stage up to and including the N^{th} operation stage; at least one shared resource connected to each of the pipeline execution units, the shared resource configured to provide information to each of the pipeline execution units and/or receive information from at least one of the pipeline execution units; a timing device for effecting operation of the pipeline execution units, such that the n^{th} operation stage of each of the pipeline execution units is executed concurrently to provide an output up to concurrent operation of the N^{th} operation stage of each of the pipeline execution units to provide an output; for at least one of the first to n=(N−1)^{th} operation stages, a device for comparing the outputs of each of the n^{th} operation stages of the pipeline execution units with each other to determine if the outputs disagree; and a device for comparing the outputs of each of the N^{th} operation stages of the pipeline execution units with each other to determine if the outputs disagree, the method including the steps of:
obtaining for each pipeline execution unit an instruction from a shared resource;
using said instruction as an input to a first operation stage of each pipeline execution unit;
for at least one of the first to n=(N−1)^{th} operation stages comparing corresponding outputs of the n^{th} operation stage of each of the pipeline execution units with each other to determine if the outputs disagree;
and, if the output of the n^{th} operation stage of one of the pipeline execution units disagrees with the corresponding outputs of n^{th} operation stage of the other pipeline execution units, the method includes the steps of:
stalling processing by all of the pipeline execution units;
disconnecting operation of the disagreeing pipeline execution unit;
recommencing processing by all of the remaining pipeline execution units after a predetermined period of time;
reconnecting, after a further predetermined time period, the disconnected pipeline execution unit; and
inputting into all of the operation stages of the disconnected pipeline execution unit, prior to its reconnection, correct inputs obtained from the corresponding operation stages one or more of the other pipeline execution units.

2. A method of operation of a microprocessor according to claim 1 including the step of additionally comparing respective outputs of the N^{th} operation stage of each of the pipeline execution units with each other to determine if the outputs disagree, and, if the output of the N^{th} operation stage of one of the pipeline execution units disagrees with the corresponding outputs of the N^{th} operation stages of the other pipeline execution units, the method includes the step of disconnecting operation of the disagreeing pipeline execution unit.

3. A method of operation of a microprocessor according to claim 1 wherein for all of the first to the N^{th} operation stages, the outputs of each of the n^{th} operation stages of each of the pipeline execution units are compared with each other to determine if any of the outputs of one of the pipeline execution units disagrees with the outputs of the other pipeline execution units, and, if the output of the n^{th} operation stage of one of the pipeline execution units disagrees with the corresponding outputs of n^{th} operation stage of each of the other pipeline execution units, the method includes the step of disconnecting operation of the disagreeing pipeline execution unit.

4. A method of operation of a microprocessor according to claim 1 wherein a second operation stage of each pipeline execution unit uses as its input an output of a first operation stage of that pipeline execution unit.

5. A method of operation of a microprocessor according to claim 1 wherein the n^{th} operation stage of each pipeline execution unit uses as its input an output of an (n−1)^{th} operation stage of that pipeline execution unit.

6. A method of operation of a microprocessor according to claim 1 wherein the n^{th} operation stage of each pipeline execution unit uses as its input an output of a shared resource.

7. A method of operation of a microprocessor according to claim 1 wherein the predetermined period of time for which processing by all pipeline execution units is stalled is one or more clock cycles of the timing device of the microprocessor.

8. A method of operation of a microprocessor according to claim 1 wherein the further predetermined time period after which the disconnected pipeline execution unit is reconnected is two or more clock cycles of the timing device of the microprocessor.

9. A method of operation of a microprocessor according to claim 1 including the step of deciding which of the pipeline execution units is the default pipeline execution unit.

10. A method of operation of a microprocessor according to claim 9 including the step of deciding which of the remaining pipeline execution units is to become the default pipeline processor, if the default pipeline execution unit is disconnected.

11. A method of operation of a microprocessor according to claim 9 wherein the default pipeline execution unit only is used to drive the at least one shared resource of the microprocessor.

12. A method of operation of a microprocessor according to claim 1 wherein, if an output of the n^{th} operation stage of at least half by number of the active pipeline execution units disagrees with the corresponding output of the n^{th} operation stage of each of the other active pipeline execution units the method includes the step of entering a recoverable fault state.

13. A method of operation of a microprocessor according to claim 12 including the subsequent step of taking recovery action(s).
